(19) United States
(12) Patent Application Publication
(10) Pub. No.: US 2014/0215059 A1
(43) Pub. Date: Jul. 31, 2014

(54) METHOD AND A TRACKER FOR CONTENT DELIVERY THROUGH A CONTENT DELIVERY NETWORK

(71) Applicants: Eguzki Astiz Lezaun, Madrid (ES); Armando Antonio Garcia Mendoza, Madrid (ES); Arcadio Pando Cao, Madrid (ES); Pablo Rodriguez Rodriguez, Madrid (ES); Parminder Chhabra, Madrid (ES)

(72) Inventors: Eguzki Astiz Lezaun, Madrid (ES); Armando Antonio Garcia Mendoza, Madrid (ES); Arcadio Pando Cao, Madrid (ES); Pablo Rodriguez Rodriguez, Madrid (ES); Parminder Chhabra, Madrid (ES)

(73) Assignee: TELEFONICA, S.A., Madrid (ES)

(21) Appl. No.: 14/116,863

(22) PCT Filed: May 7, 2012
(86) PCT No.: PCT/EP2012/058362

§ 371 Date: Mar. 12, 2014

(30) Foreign Application Priority Data
May 12, 2011 (ES) P201130757

(51) Int. Cl. H04L 12/26

(52) U.S. Cl. CPC H04L 43/0876
USPC 709/224

(57) ABSTRACT

The method comprises using a tracker for coordinating entities forming the infrastructure of the CDN, said tracker comprising a CDN layer comprising interfaces for the CDN entities and a network layer for providing network and communication services to the CDN layer.

The tracker is designed to implement the method of the first aspect.

### FIELD OF THE ART

The present invention generally relates, in a first aspect, to a method for content delivery through a Content Delivery Network (CDN), and more particularly to a method comprising using a tracker for coordinating entities of said Content Delivery Network.

A second aspect of the invention relates to a tracker designed in order to implement the method of the first aspect.

### PRIOR STATE OF THE ART

In a P2P network like bittorrent [1] [2], the tracker acts as the central coordinating entity for P2P transfer of files among the requesting end users. In BitTorrent, the tracker serves torrent files to be downloaded from a web site. The tracker maintains information about all clients utilizing each torrent.

In a classic download (typically with HTTP or FTP request), a client connects to the server (that has the content) and the file transfer occurs over a single connection. The BitTorrent protocol differs from classical download in several ways: (a) BitTorrent makes many requests of small blocks of data over different TCP connections to different machines. (b) BitTorrent downloads blocks of file in a “rarest-first” mode. In this case, the rarest pieces of the file among a peer's neighbours are downloaded first. This ensures that if one or more peer leaves the torrent, the rare file blocks remain available for download. In a classical download, the file is downloaded sequentially and all at once [1][2].

Since other clients behave as a server in distributing content, it makes BitTorrent downloads very cost effective for content owners. In addition, the BitTorrent protocol has a greater resistance to flash crowds than serving content from a server on a single connection. On the downside, since the client (or peer) downloads pieces of files from peers at different rates, he will see longer download times compared to a peer downloading a file at a high rate on a single connection.

CDNs have been around for well over a decade. As a consequence, there exist a significant number of CDN designs. However, none of them use a tracker as an element to coordinate between the elements of the CDN. CDN designs rely on using a hierarchy of DNS servers [4] or use HTTP redirection [5][7] as a way of identifying an end point or use a requesting user's location to determine the closest edge location that is best positioned [6] to serve content.

Only CoralCDN [8] is based on P2P architecture that was motivated in part by the original bitTorrent protocol [2]. However, the CDN is based on DHT and is trackerless. Only the original BitTorrent protocol uses the tracker as a central entity that aids peers in data sharing.

Trackers in P2P networks like BitTorrent have been designed to serve two primary purposes: (1) keep track of every active torrent thereby identifying both the network and end users uploading and downloading files. (2) keep track of the fragments of a file that each client possesses, thereby assisting peers in efficient data sharing. When a peer requests content for download, the tracker returns a list of peers that are part of the torrent. The client then connects to the peers and starts downloading the content file. Several P2P tracker designs have been proposed and implemented [2]. However, they are very similar in design and function. The key difference in the implementations lies in how the trackers identify fast peers for file sharing to speed up download times.

In [10], the tracker references information about other peers (who may be associated with different trackers) to come together to form a P2P cloud to speed up content sharing. This is merely a variant of the tracker design in the BitTorrent architecture. Similarly, [11] uses a variety of criteria to find fast peers to speed up content download.

The tracker in the service provider's CDN is designed with different services in mind: The tracker is designed to coordinate all of the various entities in the CDN. In addition, on request, a tracker helps an end point (or content server) identify other end points in its neighbourhood that can help exchange content when needed. Identifying peers to do a P2P content distribution forms only a very small part of the tracker design.

Next, terminology and definitions that might be useful to understand the present invention, and also the proposals cited in the present section are included.

PoP: A point-of-presence is an artificial demarcation or interface point between two communication entities. It is an access point to the Internet that houses servers, switches, routers and call aggregators. ISPs typically have multiple PoPs.

Autonomous System (AS): An autonomous system is a collection of IP routing prefixes that are under the control of one or more network operators and presents a common, clearly defined routing policy to the Internet.

Content Delivery Network (CDN): This refers to a system of nodes (or computers) that contain copies of customer content that is stored and placed at various points in a network (or public Internet). When content is replicated at various points in the network, bandwidth is better utilized throughout the network and users have faster access times to content. This way, the origin server that holds the original copy of the content is not a bottleneck.

ISP DNS Resolver: Residential users connect to an ISP. Any request to resolve an address is sent to a DNS resolver maintained by the ISP. The ISP DNS resolver will send the DNS request to one or more DNS servers within the ISP's administrative domain.

URL: Simply put, Uniform Resource Locator (URL) is the address of a web page on the world-wide web. No two URLs are unique. If they are identical, they point to the same resource.

URL (or HTTP) Redirection: URL redirection is also known as URL forwarding. A page may need redirection if: (1) its domain name changed, (2) creating meaningful aliases for long or frequently changing URLs (3) spell errors from the user when typing a domain name (4) manipulating visitors etc. For the purpose of the present invention, a typical redirection service is one that redirects users to the desired content. A redirection link can be used as a permanent address for content that frequently changes hosts (much like DNS).

Bucket: A bucket is a logical container for a customer that holds the CDN customer's content. A bucket either makes a link between origin server URL and CDN URL or it may contain the content itself (that is uploaded into the bucket at the entry point). An end point will replicate files from the origin server to files in the bucket. Each file in a bucket may be mapped to exactly one file in the origin server. A bucket has several attributes associated with it—time from and time until the content is valid, geo-blocking of content, etc. Mechanisms are also in place to ensure that new versions of the content at the origin server get pushed to the bucket at the end points and old versions are removed.

A customer may have as many buckets as she wants. A bucket is really a directory that contains content files. A bucket may contain sub-directories and content files within each of the sub-directories.

Geo-location: It is the identification of real-world geographic location of an Internet connected device. The device may be a computer, mobile device or an appliance that allows connection to the Internet to an end user. The IP-address geo-location data can include information such as country, region, city, zip code, latitude/longitude of a user.

Operating Business (OB): An OB is an arbitrary geographic area in which the service provider's CDN is installed. An OB may operate in more than one region. A region is an arbitrary geographic area and may represent a country, or part of a country or even a set of countries. An OB may consist of more than one region. An OB may be composed of one or more ISPs. Each region in an OB is composed of exactly one An OB has exactly one instance of Topology Server.

Partition ID: It is a global mapping of IP address prefixes into integers. This is a one-to-one mapping. So, no two OBs can have the same PID in its domain.

Consistent Hashing: This method provides hash-table functionality in such a way that adding or removing a slot does not significantly alter the mapping of keys to slots. Consistent hashing is a way of distributing requests among a large and changing population of web servers. The addition of removal of a web server does not significantly alter the load on the other servers.

MD5: In cryptography, MD5 is a widely used cryptographic function with a 128-bit hash value. MD5 is widely used to test the integrity of the files. MD5 is typically expressed as a hexadecimal number.

DSLAM: A DSLAM is a network device that resides in a telephone exchange of a service provider. It connects multiple customer Digital Subscriber Lines (DSLs) to a high-speed Internet backbone using multiplexing. This allows the telephone lines to make a faster connection to the Internet. Typically, a DSLAM serves several hundred residents (no more than a few thousand residents at the most).

Distributed Hash Table (DHT): Distributed hash table is a class of distributed system that provides a lookup service similar to a hash table (key, value) pairs. Any node can retrieve a value associated with a given key. The responsibility of maintaining the mapping from keys to values is distributed among the nodes in such a way that any change in the set of participants causes minimal disruption.

DHTs are used to build many complex services such as distributed file systems, peer-to-peer file sharing and content distribution systems.

The role of trackers used in P2P data transfer of bittorrent is next described:

A bittorrent tracker [1] is a server that assists communication between peers in the BitTorrent protocol[2]. Under the BitTorrent protocol:
Clients are required to communicate with the tracker to begin download (the IP address of the tracker is part of the torrent file that the end user downloads in order to begin downloading the content).
The tracker locates torrents with the same content as the requesting end user. The tracker also identifies the peers with whom the requesting end user can exchange data.
Clients that are already downloading content also communicate with the tracker periodically to get new peers and also report statistics.
Tracker communicates only with peers (end points) or other trackers.

If the tracker is taken offline, the peers will be unable to share the P2P files. More recently, the tracker functionality was decentralized using DHT making the torrents more independent from the tracker.

The requirements of a tracker in a CDN are significantly different from that of a BitTorrent tracker.

### DESCRIPTION OF THE INVENTION

It is necessary to offer an alternative to the state of the art that covers the gaps found therein, particularly those related to the lack of proposals providing the requirements a tracker implemented in a CDN needs to have.

Said requirements are:
Such a CDN tracker wouldn't have to deal with previously generated torrent files for content. As a consequence, the CDN tracker would not know about peers participating in torrents.
The CDN needs an entity (the tracker) to map content requests to end points that store and serve the content.
When an end point makes a request for content to its peers, it requests to the tracker a list of neighbours (end points) that ideally are in close physical proximity to the requesting end user (closest datacenter to the end user). Current designs of trackers are not fully equipped to handle this task although there is some progress in this area as seen in [3].
Any changes in network conditions are fed into the CDN eco-system. This enables the CDN to respond to changing conditions and find the end points that are best suited to serve content. Current trackers are not able to handle this task.

To address the requested needs, the present invention concerns to a method for content delivery through a Content Delivery Network, which comprises using a tracker for coordinating the entities that make up the infrastructure of said CDN. Said tracker has a CDN layer comprising interfaces for at least part of said entities and a network layer for providing network and communication services to said CDN layer.

Said CDN infrastructure entities are one or more of the following: origin servers, trackers, end points, topology servers, DNS servers and an entry point.

According to a second aspect, the present invention relates to a tracker for content delivery through a Content Delivery Network, that comprises a CDN layer and a network layer to address the method of the first aspect of the invention. The second aspect of the invention is therefore designed to perform the tasks of the first aspect.

Other embodiments of the method of the first aspect of the invention are described in appended claims 2 to 20, and in a subsequent section related to the detailed description of several embodiments. Said embodiments are also valid for describing the tracker of the second aspect of the invention.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows the various modules forming the tracker of the second aspect of the invention that are also used by the method of the first aspect.

FIG. 2 shows the many content exchanges between the tracker and other elements of the CDN for synchronization and for an embodiment of the method of the first aspect of the invention.

FIG. 3 shows an algorithm for disabling an end point, implemented as an API into the tracker, for an embodiment of the method of the first aspect of the invention.

FIG. 4 shows part of a DNS resolution performed with the collaboration of the tracker, for an embodiment of the method of the first aspect of the invention, where the tracker returns a list of available end points to the requesting end user.

### DETAILED DESCRIPTION OF SEVERAL EMBODIMENTS

Next, each component of the CDN service provider's sub-system is described. The infrastructure consists of Origin Servers, Trackers, End Points and Entry Point.
Publishing Point: Any CDN customer may interact with the CDN service provider's infrastructure solely via the publishing point (sometimes also referred to as the entry point for simplicity). The publishing point runs a web services interface with users of registered accounts to create/delete and update buckets.

A CDN customer has two options for uploading content. The customer can either upload files into the bucket or give URLs of the content files that reside at the CDN customer's website. Once content is downloaded by the CDN infrastructure, the files are moved to another directory for post-processing. The post-processing steps involve checking the files for consistency and any errors. Only then is the downloaded file moved to the origin server. The origin server contains the master copy of the data.
End Point: An end point is the entity that manages communication between end users and the CDN infrastructure. It is essentially a custom HTTP server.
Tracker: The tracker is the key entity that enables intelligence and coordination of the CDN service provider's infrastructure. This invention describes the design of the tracker and its function as a key component of the CDN infrastructure.
Origin Server: This is the server(s) in CDN service provider's infrastructure that contains the master copy of the data. Any end point that does not have a copy of the data can request it from the origin server. The CDN customer does not have access to the origin server. CDN service provider's infrastructure moves data from the publishing point to the origin server after performing sanity-checks on the downloaded data.
Topology Server: The information about the network topology of an OB is maintained in its topology server. The network topology is really a cost matrix across network paths. The cost matrix is used by the CDN in choosing the path when delivering content to the end point.

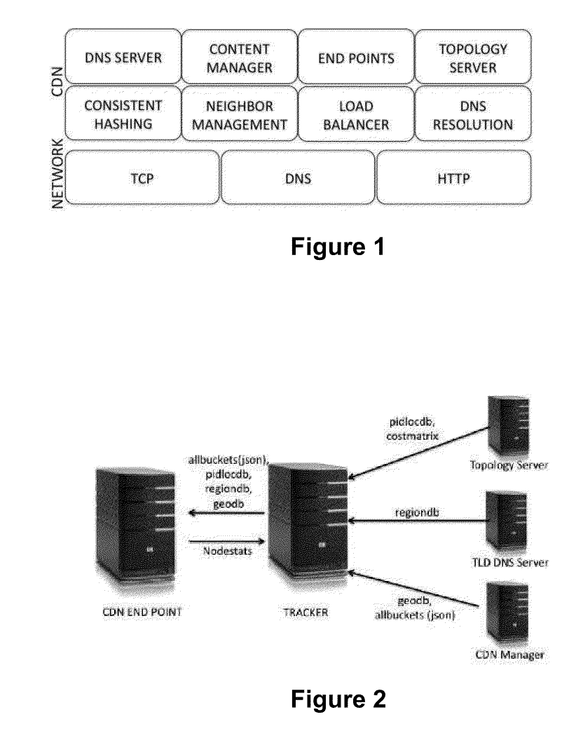

Next, with reference to FIG. 1, a detailed architecture of the tracker in a service provider's CDN is described. This is valid for both the tracker of the second aspect of the invention and also the tracker used by the method of the first aspect of the invention.

The primary functions of the CDN tracker are coordinating the various CDN elements, helping synchronize information between CDN elements and end points, participating in DNS resolution, identifying least loaded end points that are best positioned to serve content to requesting end users, using current network information to identify the least cost path between a requesting end user and a serving end point. The tracker is also the element that maps content to end points using consistent hashing [1][9].

The tracker detailed in this invention is the entity that enables intelligence and coordination among elements in the CDN infrastructure. The tracker also helps balance the load across all the end points in the OB that deploys the CDN. Generally, there is exactly one tracker deployed per region in an OB. The tracker design consists of two layers: the network layer and the CDN layer (see FIG. 1).

The network layer provides transport and communication services to the CDN layer. The transport services are via standard protocols: TCP, HTTP. The tracker also participates in DNS resolution. The CDN layer consists of: Consistent hashing module, Neighbour Management module, load balancer module and the DNS resolution module.

In addition, the tracker has a web services interfaces for communication with the End points and the CDN content manager, Topology server and the DNS server.

### Tracker Interfaces:

The tracker maintains interfaces with the following four entities of the CDN eco-system: end point, CDN manager, topology Server and DNS Server. The communication with each of the CDN entities occurs via RPCs. The RPCs may take any format: XML, binary, json object, REST API call etc with HTTP as a transport mechanism. The interfaces between the tracker and other CDN entities are the following (see FIG. 1):

End Point:

The tracker (a) maintains information about content at each end point and (b) collects statistics periodically from each end point. The tracker maintains the following information from each end point: The end point reports the number of outbound bytes, number of inbound bytes between two reporting periods, available free disk space and number of active connections for each bucket. The tracker uses this information to infer the load on an end point.

In response to the end point statistics, the tracker returns a list of active neighbours to the end point. This ensures that at each time, every end point has a fresh set of active neighbours that it can use for P2P communication.

CDN Manager:

Any change in the meta-data of a bucket (or the file in a bucket) by a customer is reflected at the CDN Manager immediately. Since the tracker synchronizes the buckets with the CDN Manager periodically, any change in the bucket meta-data is reflected at the tracker. The tracker also synchronizes with the end points frequently. So, any change in the meta-data of the bucket (or any file in a bucket) at the CDN manager is propagated to the end points in a very short time.

DNS Server:

The tracker gets a file that contains information about regions, called regionsdb from the TLD DNS server.

This information is useful for an end point in order to determine the region of an originating request. If the region of the originating request is not the same as that of the end point, the end point returns a HTTP 302 while encoding the region as part of the URL. When the end user makes a request for the new URL, the TLD DNS server identifies the correct region and forwards the request to the DNS server authoritative for that region.

The regionsdb is also useful in performing geo-blocking of clients from content that may not be viewed from certain locations.

Topology Server:

The tracker fetches information about the partitions (or subnets), pidlocdb and the cost-matrix (called costmatrix) between partitions (or subnets) from the topology server. It gets both the pieces of information periodically.

### Tracker Interactions:

The interaction of the tracker is summarized as follows, and illustrated in FIG. 2 for a synchronization process between the tracker and the elements of the CDN:

Tracker and End Points:

(1) allbuckets: This is called to get information about buckets. No information is returned if the buckets have not changed since last request (i.e. no new bucket was created and there was no change in meta-data of any bucket).

end points->tracker: HTTP GET request

tracker->end points: HTTP response

(2) updateNodeStats: Called periodically by end points to report node level statistics (via HTTP POST). In return, a list of active neighbours is piggybacked to the end point.

end points->tracker: HTTP POST

tracker->end points: HTTP response to POST and list of active neighbours of the end point serving the statistics.

(3) updateRegionsdb: Called to get the latest Regiondb. Only new updates are sent rather than the entire database. Every time a new region is created/removed by OBs, the regiondb table is updated. Since end points help resolve DNS requests, the latest regiondb table needs to be propagated to the end points as soon as a new region is created.

end points->Tracker: HTTP GET request

Tracker->end points: HTTP response with a copy of the regiondb.

(4) pidlocdb: Called by an end point to return the PID & IP prefix/mask associated with each region in an OB.

end points->Tracker: HTTP GET request

Tracker->end points: HTTP response with a copy of the pidlocdb

Tracker and DNS Server:

(1) Get regiondb to identify the list of endpoints for a bucket id and geographic information. In case of changes in regiondb, only the updates are sent.

end points->DNS Server: HTTP GET request

DNS Server->end points: HTTP response with a copy of the regiondb.

Tracker and CDN Manager:

(1) allbuckets: Get all buckets from the publication manager that resides at the publication server.

tracker->CDN manager: HTTP GET

CDN manager->tracker: HTTP response

(2) geodb: Get the latest geo-location database from the CDN manager. This is useful in order to ensure that the end points allow requests for content to proceed only if the requesting end user belongs to a region where the content may be shown.

tracker->CDN manager: HTTP GET

CDN manager->tracker: HTTP response with a copy of the geo-location database.

Tracker and Topology Server:

(1) pidlocdb: Get the list of PIDs (partition IDs and the corresponding IP prefixes) from the topology server that maintains the latest PID/IP prefixes pairs for all regions.

tracker->topology server: HTTP GET

topology server->tracker: HTTP response with a copy of the PID location database.

(2) costmatrix: Get the unidirectional cost of transferring data between all PIDs (path between PID in row i and PID in column j for all i and j, where i and j are PIDs). If the path between two PIDs does not exist, the matrix location for such a path contains a negative value that is not considered in calculating the cost.

tracker->topology server: HTTP GET

topology server->tracker: HTTP response with a copy of the cost matrix.

The tracker uses the costmatrix received from the Topology server to determine routing between source and destination (requesting end user) PIDs.

### Tracker as a Load Balancer:

Since all requests to identify the end point that is best positioned to serve content come through the tracker, it is the natural element to balance end user requests across all of the end points.

As per the design of the DNS sub-system in the service provider's CDN the tracker load-balances the requests across end points that are not heavily loaded. This allows the CDN infrastructure to scale with the number of requests. The end points in turn either (a) send a HTTP 302 Redirect message to the requesting end user or (b) identify themselves as best positioned to serve content.

The tracker may load-balance the requests by either one of the following algorithms (a) round-robin, (b) geographic location while giving preference of end points in the same region or (c) any policy that associates content with a small subset of end points (either because of the popularity of the content or because end points are configured serve only certain type of content).

The resource management mechanism is designed to allow the CDN to balance the requests across the CDN's end points. To balance the load, we use consistent hashing.

A key reason to use consistent hashing is that adding a node or taking down a node does not significantly change the mapping of content to end points. In contrast, for traditional hash tables, changing the number of end points causes nearly all the content to be mapped to the end points.

### Resource Management Mechanism:

The resource management mechanism at the tracker accomplishes the following: (1) It maps content to end points that are distributed geographically within a country or a region. (2) It maintains a mapping of IP subnet addresses to partition IDs. By identifying the PIDs of the end user, and knowing the PID of the content, the end point knows if the requested content may be served or must be geo-blocked. (3) The end point uses a PID matrix that has weights associated with every pair of PIDs. This allows the resource management mechanism to identify the best PID (and therefore, the subnet) that can serve content. Subsequently, the tracker forwards the request to the end point that has the content in the PID identified in the previous step.

The end point serves as a redirector for a client request. As part of this redirection, the end point needs to identify the PID that may best serve the content. This identification is performed using consistent hashing at the end points.

### Enable and Disable End Points:

From time to time, end points may need to be brought down either for maintenance or because they need to be replaced/upgraded. For ease of administration, we provide the CDN administrator, the ability to bring down end point(s). Similarly, we also provide API calls to enable and disable end points.

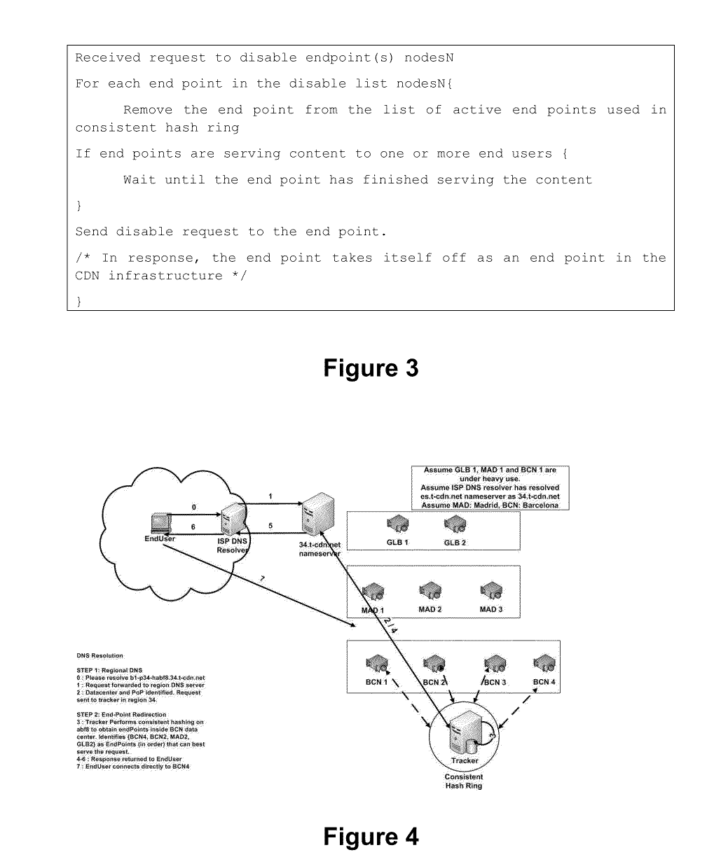

End points can be disabled at the tracker with an API call. The /api/tracker/policies/disablenodes is called with a JSON object like: {‘disabled_endpoints’: [node0, node1, . . . , nodeN−1]}. Here, node0 to nodeN−1 are a list of IP addresses that need to be disabled by the tracker. A detailed description for disabling an end point is presented in FIG. 3, for an embodiment.

Prior to disabling an end point, the tracker ensures that (1) no end user is accessing content at the end point (and if they are accessing content, the tracker ensures that the end point finishes processing ongoing requests). (2) The end point is no longer considered to be part of the CDN infrastructure when directing subsequent requests for content from end users to end points.

The corresponding API call to enable endpoints, namely enablenodes is called with a JSON object like: {‘enable_endpoints’: [node0, node1, . . . , nodeN−1]}. Here, node0 to nodeN−1 are a list of IP addresses that need to be enabled by the tracker.

When an end point joins: An end point is handed the address of the tracker as part of the configuration. As part of the initialization, the end point contacts the tracker. The end point keeps an open connection with the tracker. This allows the tracker to know the status of every end point. The end points use this connection to send the node statistics to the tracker periodically.

If the connection closes unexpectedly, the end point will attempt to reconnect with the tracker by opening another connection.

When an end point leaves unexpectedly: If the tracker does not receive statistics update from an end point for a period of time (or the connection with the tracker breaks), it assumes that the end point is no longer part of the CDN infrastructure. As a result, the tracker does not take into account such a node for content distribution (and hence, for consistent hashing or as a neighbour for the other end points).

### Finding Geographically Close Peers:

The tracker is responsible of returning a list of end points that are best positioned to serve requested content to the end user. It is described as part of the DNS resolution process here that deals with returning a list of end points to the end user.

### Geo-Location of End Points at a Tracker:

The tracker has a list of parameters for each end point to aid in geo-location. These parameters are:

IP address: The tracker infers the geographic location of the end point using its IP address and the mask.

Site ID: This provides better location information. A tracker may use the Site ID to determine if two end points may use exchange data using P2P protocol. Within the same datacenter, a CDN service provider may label cluster of machines on different floors as having different site IDs (network connectivity between floors may vary).

PID: The tracker may determine the PID of the end point using the pidlocdb database to infer the partition ID and then use the Site ID to infer if two machines are really co-located.

The tracker also has access to Geo-IP database (called geodb) that it can be used to identify the location of an IP address (end points). The IP address, together with the geodb helps the tracker resolve an end point when needed.

While a very fine-grained Geo-IP database may resolve an IP address at the block level, using Site ID we are able to resolve the location of a cluster of machines within a datacenter. This gives our tracker better resolution when identifying geo-located machines. Note that we may use PID database instead of a Geo-IP database without compromising on the accuracy of geo-location.

### Identifying Busy End Points:

In addition, the tracker maintains the following information about each end point (this information is reported by each end point every minute or every few minutes):
cpuload: This is the CPU load at the end point.
diskAvailable: This is the remaining disk-space at the end point.
activeConnectionCount: This is the total number of currently active connections at the end point.
outboundBytespers: This is the rate at which end-users download content from the end point (in bytes/second).
inboundBytespers: This is the rate at which the end point ingests content (in bytes/second).

These parameters allow the tracker to infer what end points may be regarded as busy. Since end points report their parameters every 30 seconds (or few minutes), the tracker always has the latest information for every end point. Individual CDN service providers may use a combination of the above parameters to decide what constitutes a busy end point. The tracker when responding to end user requests does not use end points identified as busy.

### DNS Resolution:

As part of the DNS resolution request, the tracker must find end points that are geographically close to the requesting end users.

In describing the DNS resolution, the following assumptions are made: The end user has made a request for video01.fly that generates a request to the CDN of the format bucket_id.t-cdn.net/bucket_id/video01.fly. Using a bucket_id=87, the request is of the form b87.t-cdn.net/87/video01.fly.
(1) The ISP DNS resolver identified the TLD DNS server for the .net domain to resolve t-cdn.net. Subsequently, the DNS server authoritative for t-cdn.net infers the request to be for the region 34.t-cdn.net.
(2) The first step of DNS resolution has already occurred within the CDN infrastructure: An end point has returned a consistent hash on the URL and returned a HTTP 302, Moved Location to the end user with the URL b87-p34-habf8.34.t-cdn.net/87/video01.fly. Here b87 is bucket id 87, p34 is for region 34 and habf8 is the hexadecimal representation, abf8=sub-string(MD5(URL)).
(3) In this example (set in Spain), the end user is based in Gerona (a town about 100 Km outside Barcelona). The CDN service provider has local datacenter in Barcelona, a national datacenter in Madrid and a global datacenter in London. So, a content request will return a set of IP addresses that contains end points in {closest datacenter, next closest datacenter, national datacenter, global datacenter}. The number of IP addresses in each set of closest, next closest, national and global datacenter may vary.
   A detailed step-by-step DNS resolution is next described with reference to FIG. 4:
(0) The end user makes a request for b87-p34-habf8.34.t-cdn.net/87/video01.flv.
(1) The ISP DNS server forwards this request to the authoritative DNS server for region 34 (say es.t-cdn.net) in the t-cdn.net domain.
(2) The DNS server authoritative for region 34, 34.t-cdn.net forwards the request to the tracker for region 34.
(3) The tracker for region 34 performs consistent hash on abf8 to obtain {BCN4, BCN2, MAD2 and GLB2} as end points that can best serve the request.
   a. Note that the list is ordered by the closest and least loaded end point. The closest end points may be identified as defined above. End points in national and global datacenters are also chosen in addition to the closest datacenter as a fallback. Here, BCN2 and BCN4 are chosen from the Barcelona datacenter. Similarly, MAD2 and GLB2 are chosen.
   b. The process that helps identify the least loaded end points was previously described. The tracker then determines that end point BCN4 is less loaded than BCN2.
   c. An ordered list is created using the above two points. Thus, the tracker creates the ordered list {BCN4, BCN2, MAD2 and GLB2}.
(4)-(6) The list of end points that may serve content is returned to the end user.
(7) The end user directly attempts to connect to the end point BCN4.

If the end user fails to connect to the end point BCN4, the end user tries to connect to BCN2, MAD2 and GLB2 in that order.

### Neighbour Manager:

The Tracker has a neighbour manager module. When the tracker sends a list of neighbours to a requesting end point, it orders the end points (neighbours as follows):

First, the tracker orders the end points by IP addresses (or IP prefixes). So, end points returned are part of the same datacenter. The tracker may also use PID and/or Geo-IP database to infer this information.

For the set of IP addresses that belong to the same prefix, but different site IDs, it orders the neighbours by site ID.

The set of IP addresses received by an end point are then used to engage in P2P communication when sharing content between end points in the same datacenter.

### Implementing Policies:

The service provider may need to implement a number of policies in the CDN. The tracker at the CDN is the best placed to both implement and police the implementation of these policies. The policies that may be implemented are:
(1) Reserving some customer buckets to reside on some end points. When content requests are received for content in such buckets, the tracker directs the request only to end points that are reserved to serve such content. The tracker orders the end points and returns them to the requesting end user.
(2) Reserving some end points for certain customers. This allows the CDN service provider to offer premium service to certain customers by reserving some end points for their use exclusively. The implementation of this policy is the similar to (1) above.
(3) Reserving an end point to serve only certain type of content.
   The tracker uses an API call to change the change the capability of an end point. This allows an end point to be reserved (say) to serve only live content. So, only live buckets may be mapped to this end point.
   As a consequence, when mapping content to end points, the consistent hash ring first checks if an end point is configured to serve such content. So, prior to mapping a live bucket to an end point, the tracker checks to make sure that the end point is configured to serve live content. Likewise, when answering an end user request for live content, the tracker first checks if the end point can serve live content before it builds a list of end points capable of serving such content.
(4) Allow a CDN service provider to set policies on what constitutes a busy end point.
   The CDN service provider may configure the thresholds on end point parameters (cpuload, diskAvailable, activeConnectionCount, outboundBytespers and inboundBytespers), either individually or any combinations with conjunctions or disjunctions. This configuration information is passed to the tracker via an API call. The tracker then ensures that any end point that meets the criteria is marked as ‘busy’. Such end point(s) are not considered by the consistent hash function when serving end user requests.

As seen above, the tracker is the most appropriate place to implement and police the policies of the CDN service.

### ADVANTAGES OF THE INVENTION

The tracker is the entity that provides synchronization and coordination among the entities in the service provider's CDN.
Any change in the content in a customer's bucket is reflected at the end point(s) within a very short time. The tracker acts as a proxy for the CDN customer bucket.
The tracker acts as a load balancer in the CDN by identifying the least loaded and closest end point that may be best positioned to serve the content to a requesting end user.
The tracker helps the DNS infrastructure by identifying both the geographically closest end points (in the nearest datacenter) to serve content and backup end points in case the closest end point is unable to serve the content.
The list of end points returned by the tracker comprises of the closest and least loaded end point, end points in a fall back datacenter in case the closest datacenter cannot serve the content (for whatever reason) and the global datacenter that is the fallback in case the machines in the previous two cases are unable to serve content.
The tracker also helps an end point locate other end points in its neighbourhood (same datacenter). This allows the end points to share content in a P2P fashion without the need to always get content from the origin server.
The tracker also defines an API to control the functioning of end points via tracker. This allows the CDN service provider to define and implement policies in the CDN infrastructure:

a) Enabling and disabling end points.

b) Reserving content buckets to reside on specific end points (and no others).

c) Reserving end points to serve a type of content (e.g. serve only live content from and end point).

A person skilled in the art could introduce changes and modifications in the embodiments described without departing from the scope of the invention as it is defined in the attached claims.

### ACRONYMS AND ABBREVIATIONS

ADSL ASYMMETRIC DIGITAL SUBSCRIBER LINE
CDN CONTENT DISTRIBUTION NETWORK
DNS DOMAIN NAME SERVICE
POP POINT OF PRESENCE
OB OPERATING BUSINESS
TLD TOP LEVEL DOMAIN
FTP FILE TRANSFER PROTOCOL
HTTP HYPERTEXT TRANSFER PROTOCOL
MD5 MESSAGE-DIGEST ALGORITHM 5
URL UNIFORM RESOURCE LOCATOR
ISP INTERNET SERVICE PROVIDER
TTL TIME TO LIVE
DSLAM DIGITAL SUBSCRIBER LINE ACCESS MULTIPLEXER
DHT DISTRIBUTED HASH TABLE
PID PARTITION IDENTIFIER
RPC REMOTE PROCEDURE CALL

### REFERENCES

[1] BitTorrent Tracker. At http://en.wikipedia.org/wiki/BitTorrent_tracker
[2] BitTorrent Protocol. At http://en.wikipedia.org/wiki/BitTorrent_(protocol)
[3] P4P: A Portal for Proactive Providers Participating in P2P. At http://cs-www.cs.yale.edu/homes/yong/p4p.html
[4] Akamai. http://www.akamai.com
[5] Limelight Networks, http://www.limelightnetworks.com/
[6] Amazon Cloudfront, http://aws.amazon.com/cloudfront/
[7] Edgecast, http://www.edgecast.com/
[8] M. J. Freedman, E. Freudenthal, and D. Mazières, “Democratizing Content Publication with Coral.” In Proc. NSDI, San Francisco, Calif., March 2004.
[9] Consistent Hashing. At http://en.wikipedia.org/wiki/Consistent_hashing
[10] C. Gkantsidis, J. Miller, M. Costa, P. Rodriguez, S. Ranson, “Connection management in peer-to-peer content distribution clouds.” United States Microsoft Corporation (Redmond, Wash., US), 7849196 http://www.freepatentsonline.com/7849196.html
[11] J. Czechowski III, W. D. Smith II, X. Wang, C. D. Carothers, “Accelerating Peer-to-Peer Content Distribution.” United States GENERAL ELECTRIC COMPANY (SCHENECTADY, NY, US), 0182815 http://www.freepatentsonline.conn/y2009/0182815.html

1-22. (canceled)

23. A method for content delivery through a Content Delivery Network, comprising coordinating entities forming the infrastructure of a Content Delivery Network or CDN, by using a tracker including a CDN layer with interfaces for at least some of said CDN entities and a network layer for providing network and communication services to said CDN layer, wherein said method further comprises said tracker performing following actions:
identifying other neighbouring end points in the tracker's neighbourhood, by collaborating with an end point or content server of said CDN which can help for exchanging content when needed;
returning, when receiving a content request from an end user, a list of said neighbouring end points that are ideally in close physical proximity to the requesting end user;
mapping content buckets of said neighbouring end points that store and serve requested content;
making the CDN respond to changing network conditions by finding the neighbouring end points that are best suited to serve content, by at least:
identifying the least loaded of said neighbouring end points that are best positioned to serve content to requesting end users, or
identifying the least cost path between a requesting end user and a serving end point; and
collaborating in DNS resolution via a corresponding service provider by said network layer.

24. A method as per claim 23, wherein said CDN infrastructure entities are at least one of: at least one origin server, at least one tracker, end points, at least one topology server, at least one DNS server and an entry point or publishing point.

25. A method as per claim 23, wherein said mapping of content buckets to end points is performed by using consistent hashing.

26. A method as per claim 23, comprising using said tracker such that on receiving a content request from an end user, a list of neighbouring end points are returned that are ideally in close physical proximity to the requesting end user.

27. A method as per claim 23, comprising using said tracker for collaborating in balancing the load across all the end points in the Operating Business, or OB, that deploys the CDN.

28. A method as per claim 23, wherein said tracker's network layer provides transport and communication services to the CDN layer and said transport services being performed via TCP and HTTP protocols.

29. A method as per claim 23, wherein the CDN layer of said tracker comprises a consistent hashing module, a Neighbour Management module, a load balancer module and a DNS resolution module.

30. A method as per claim 23, wherein the CDN layer of said tracker comprises interfaces for at least some of the next CDN entities: end points, content manager, topology server and TLD DNS server.

31. A method as per claim 30, wherein the communication of the tracker with each of the CDN entities occurs via RPCs.

32. A method as per claim 30, comprising using said tracker end point interface for maintaining information about content at each end point and collecting statistics periodically from each end point, to at least infer the load on an end point.

33. A method as per claim 30, comprising using said tracker content manager interface for synchronizing buckets with the content manager periodically, in order to detect any change in meta-data associated to said buckets and propagate said detected changes to the end points with which it synchronizes via said tracker end point interface.

34. A method as per claim 30, comprising using said tracker DNS server interface for acquiring information about regions from a TLD DNS server.

35. A method as per claim 30, comprising using said tracker topology server for fetching information about partitions, or subnets, PID location database and the cost-matrix between partitions from the topology server.

36. A method as per claim 23, comprising defining an API into said tracker to control the functioning of end points via tracker, said API allowing at least enabling/disabling end points.

37. A method as per claim 23, comprising defining an API reserving content buckets to reside on specific end points and reserving end points to serve certain types of content.

38. A tracker for content delivery through a Content Delivery Network, including a CDN layer with interfaces for at least some CDN entities and a network layer for providing network and communication services to said CDN layer, the tracker further comprises:
means to identify other neighbouring end points, by collaborating with an end point or content server of said CDN which can help for exchanging content when needed;
means for returning, when receiving a content request from an end user, a list of said neighbouring end points that are ideally in close physical proximity to the requesting end user;
means for mapping content buckets of said neighbouring end points that store and serve requested content;
means for making the CDN respond to changing network conditions by finding the neighbouring end points that are best suited to serve content; and
means for collaborating in DNS resolution via a corresponding service provider by said network layer.
